(19) United States
(12) Patent Application Publication
(10) Pub. No.: US 2005/0015342 A1
(43) Pub. Date: Jan. 20, 2005

(54) Check processing apparatus, POS system and method for processing checks when processing transactions using a POS terminal computer

(76) Inventors: Sadao Murata, Matsumoto-shi (JP); Hiroshi Ono, Shiojiri-shi (JP)

Correspondence Address: ANDERSON, KILL & OLICK, P.C., 1251 AVENUE OF THE AMERICAS, NEW YORK,, NY, 10020-1182, US

(21) Appl. No.: 10/836,758

(22) Filed: Apr. 30, 2004

(30) Foreign Application Priority Data
May 2, 2003 (JP) 2003-127311

(51) Int. Cl. G06F 17/60

(52) U.S. Cl. 705/45; 705/17

(57) ABSTRACT

A check processing apparatus, system and method for effectively and efficiently preventing illegal check use when processing sales transactions based on product information entered by an operator in a POS terminal computer including a scanning device for capturing an image of personal identification of the presenter of the check. The check processing apparatus includes means for reading check-specific information preprinted in magnetic ink on the check C and identifying the check; and a controller for evaluating the check-specific information. The scanning device is activated based upon the result of this evaluation. The scanning device may comprise a photo-ID scanner for capturing the image of identification.

### BACKGROUND OF THE INVENTION

1. Field of Technology

The present invention relates to a check processing apparatus adapted to be connected to a point-of-sale (POS) terminal computer for processing checks when processing transactions based on product information entered by an operator, and relates more particularly to a check processing apparatus and POS system capable of capturing an image of personal identification presented by a person using a check so that the image can be used as crime evidence in the event the check was used illegally.

2. Description of Related Art

Payment systems using checks are common in the United States and other countries. The checks are typically payroll checks C1 such as shown in FIG. 8(a), and personal checks C2 such as shown in FIG. 8(b). Payroll checks C1 are typically two-party checks that are issued by one party to a second party and may be represented by company checks (business checks) used by corporations to pay employees e.g., two-party payroll check C1. Personal checks C2 are used by individual users and are drawn on the user's own account. Payment of the check requires the presenter to sign the check before it is presented for payment.

As check-based payment systems have grown, however, so have damages resulting from check forgery and other illegal check usage. In the United States alone, annual losses due to illegal check use and bad checks are said to exceed one billion dollars, and more than a million bad checks are said to be found in the checking system every day. To reduce these losses, stores (retail stores) commonly require the check user to present a driver license or other type of photo identification so that the clerk can visually verify the user's name and face. If the driver license has been forged, however, this method cannot be used to identify forged checks, and no evidence that can later be used to prove that the check was forged is left. Furthermore, while some stores have the clerk write the driver license number on the check, transcription errors can occur, and such transcriptions alone are therefore insufficient evidence.

Addressing this problem, identity verification systems for verifying individuals based on a credit card or check presented by a user by referencing a database of personal identification information including such credit card and checking account information as well as a photograph of the account holder have been proposed in the United States. See, for example, Japanese Published Patent Appl. H11-509015, FIG. 1 (Image Data LLC).

However, there is at present no commercially available database containing the personal information of a significant number of people throughout the entire United States, and no infrastructure to access such information. Moreover, identity verification systems which would require a database of the general public can not be anticipated in the foreseeable future.

To resolve the above problems, the present invention therefore provides a check processing apparatus, system and method for processing checks when processing transactions using a POS terminal computer for effectively and efficiently preventing illegal use of checks in order to minimize risk associated with bad checks or insufficient funds

### SUMMARY OF THE INVENTION

A check processing apparatus according to the present invention is adapted to be connected to a POS terminal computer for transaction processing based on product information entered by an operator, and comprises:

a scanning device for imaging personal identification information of a person presenting a check;

a check reading means for reading check-specific information preprinted in magnetic ink to the check and identifying the check;

evaluation means for evaluating check-specific information on said check in accordance with predefined evaluation standards; and

a scanning determination means for determining whether to activate said scanning device to capture an image of said personal identification based on the evaluation result of said evaluation means.

The check processing apparatus of the present invention can quickly scan and store an image of personal identification of the person presenting the check for payment by means of a scanning device for capturing an image of personal identification of the presenter of the check. The captured image can then be used as evidence of a crime in the event of illegal use (such as check forgery).

Furthermore, the identification is not scanned for all check users. Instead, the check-specific information printed in magnetic ink to the check is read, and specific information contained in the check-specific information is evaluated to determine whether to scan the identification. By thus scanning identification only when a check for an amount that could result in large financial loss is used (such as when the check is a payroll check used to pay wages), proof of use of a high risk check can be efficiently created without lowering overall productivity.

This check processing apparatus further preferably also has a reporting means for reporting the evaluation result from the specific information evaluation means and/or the decision of the scanning determination means.

The method of the present invention for processing checks when processing transactions relative to product information using a POS terminal computer and a check processing apparatus including a scanning device for scanning an image of the presenter of each check comprises the steps of:

(a) establishing a set of evaluation conditions for evaluating each check presented in payment of product processed by the POS terminal computer;

(b) capturing an image of personal identification of the person presenting the check when the set of evaluation conditions are satisfied of the present invention.

The operator of the check processing apparatus can thus know whether to scan the identification based upon the set of evaluation conditions which can be set and reset from the POS terminal computer.

By determining to scan identification if the check is a payroll check used for paying wages or other such two-party check, the loss can be minimized in the event the check is used illegally because a the presenter that illegally used the check can be identified using the facial picture captured from the identification and the likelihood of recovering the funds is increased. That is, a personal check is written for the amount of products purchased and any loss is therefore relatively small if the check is bad, but payroll checks are used to pay wages, are therefore usually written for relatively large amounts that must be paid to the presenter (user), and can thus result in greater financial loss.

Yet further preferably, the check processing apparatus also has an evaluation standard acquisition means for acquiring evaluation standards used for comparison by the specific information evaluation means, and the specific information evaluation means determines if the evaluation standard is found in the check-specific information.

Whether to scan and image the personal identification is decided in this case based on whether the evaluation standard is found in the check-specific information. For example, information relating to high risk companies (such as companies with a history of dishonored checks or at risk of bankruptcy) can be acquired as the evaluation standard, and identification could be required and scanned only for users presenting checks issued by such high risk companies. High risk checks can thus be identified and processed appropriately without requiring the POS terminal operator to make the decision.

The check processing apparatus further preferably comprises an evaluation standard configuring means for setting the evaluation standard.

This configuration enables setting the evaluation standard and conditions according to the location of the business using the check processing apparatus or current conditions. The business could also set these conditions based on its own criteria.

Yet further preferably, the evaluation standard is supplied over a network.

Because the information used as the evaluation standard is thus supplied over a network, the same information can be efficiently acquired by all POS terminals in a store that has multiple POS terminals, and all check-specific information can therefore be reliably evaluated based on the same standard.

Yet further preferably, the check-specific information includes account information denoting a checking account on which the check is drawn, and the evaluation standard is said account information.

By evaluating the check-specific information based on account information contained in the check-specific information, if account information for an account of a company considered high risk is detected, the information can be used to determine whether to scan the presenter's identification.

Yet further preferably, the check processing apparatus also has a transaction information acquisition means for acquiring transaction amount information from the POS terminal computer; a reference amount setting means for setting a reference amount for evaluating the transaction amount; and a transaction amount evaluation means for determining if the transaction amount exceeds the set reference amount. The scanning determination means decides to scan and image the personal identification when the transaction amount evaluation means determines the transaction amount exceeds the reference amount.

Because an image of presented personal identification is captured when the transaction amount is determined to exceed the reference amount, evidence of a crime can be created if the check is later found to be have been used illegally and the loss is great. Losses can therefore be minimized.

Furthermore, the identification is not scanned for all check users. Instead, identification is scanned based on whether the transaction amount exceeds a set reference amount. By thus scanning identification only when a check for an amount that could result in large financial loss is used, proof of use of a high risk check can be efficiently created without lowering overall productivity.

The check processing apparatus can quickly scan and store an image of presented identification by means of the scanning means for capturing an image of personal identification presented by a person using a check. The captured image can then be used as evidence of a crime in the event of illegal use (such as check forgery).

Furthermore, the identification is not scanned for all check users. Instead, identification is scanned based on whether set evaluation criteria are met. As a result, depending upon how the evaluation criteria are defined, proof of use of a high risk check can be efficiently created without lowering overall productivity. In addition, because the POS terminal operator can set the evaluation criteria, the criteria can be set according to the specific needs of the store.

In this case, the criteria used as evaluation conditions are one or a combination of two or more of the following: (a) the check is a payroll check or other two-party check issued by someone other than the presenter and payable to the presenter upon signing by the presenter, (b) preset evaluation criteria for evaluating the check-specific information is contained in the check-specific information, and (c) the transaction amount exceeds a preset reference amount.

This enables setting according to the specific needs of the store or business one or a combination of two or more specific conditions as the evaluation criteria, specifically whether the check is a payroll check or other two-party check that is issued by someone other than the presenter and is payable to the presenter upon signing by the presenter, whether standard evaluation information preset for identifying the check-specific information is contained in the check-specific information, and whether the transaction amount exceeds a set reference amount.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a schematic diagram of a POS system according to a preferred embodiment of the invention;

FIG. 2 is an external view of a hybrid processing system containing the function of a check processing apparatus according to a preferred embodiment of the invention;

FIG. 3 is a schematic side view of a hybrid processing system containing the function of a check processing apparatus according to a preferred embodiment of the invention;

FIG. 4 is a control block diagram of a POS system according to a preferred embodiment of the invention;

FIG. 5 is a flow chart of a method for setting evaluation criteria according to a preferred embodiment of the invention;

FIG. 6 is a flow chart describing a check processing method according to a preferred embodiment of the invention;

FIG. 7 is a control block diagram of a POS system according to a second embodiment of the present invention; and

FIG. 8 shows examples of conventional checks.

### DESCRIPTION OF THE PREFERRED EMBODIMENTS

The check processing apparatus, method and POS system according to preferred embodiments of the present invention are described in detail below with reference to the accompanying figures. Our invention incorporates into a POS terminal a photo ID scanner for scanning and capturing an image of personal identification presented by a person using a check. An image of the identification can therefore be quickly captured at the point of sale, and can later be used as evidence in the event of forged checks and other illegal uses. Furthermore, this invention does not scan identification for all users, but instead reads specific check information preprinted in magnetic ink on the check, makes a decision using the specific check information read from the check, and captures an image of the identification based on the result of this decision.

As a result, when a check that could result in great loss is presented and accepted, our invention can create proof of a high risk check (a record of a crime) without lowering productivity by requiring identification and imaging that identification while processing the check.

The present invention is therefore described below using by way of example a POS terminal such as used in restaurants and retail stores, and hybrid processing system that can be used with this POS terminal. The hybrid processing system has the functions of a photo ID scanner, check processing apparatus, magnetic ink character reader (MICR), check printer, and receipt printer. The invention is therefore also described with reference to a POS system having such a POS terminal.

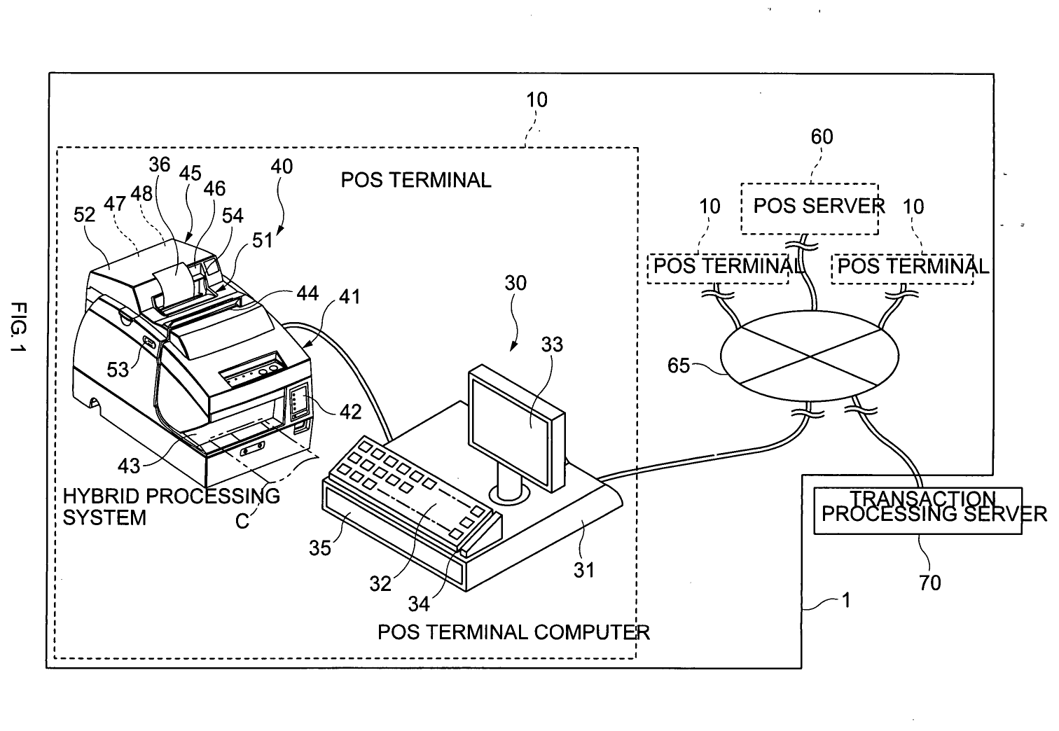

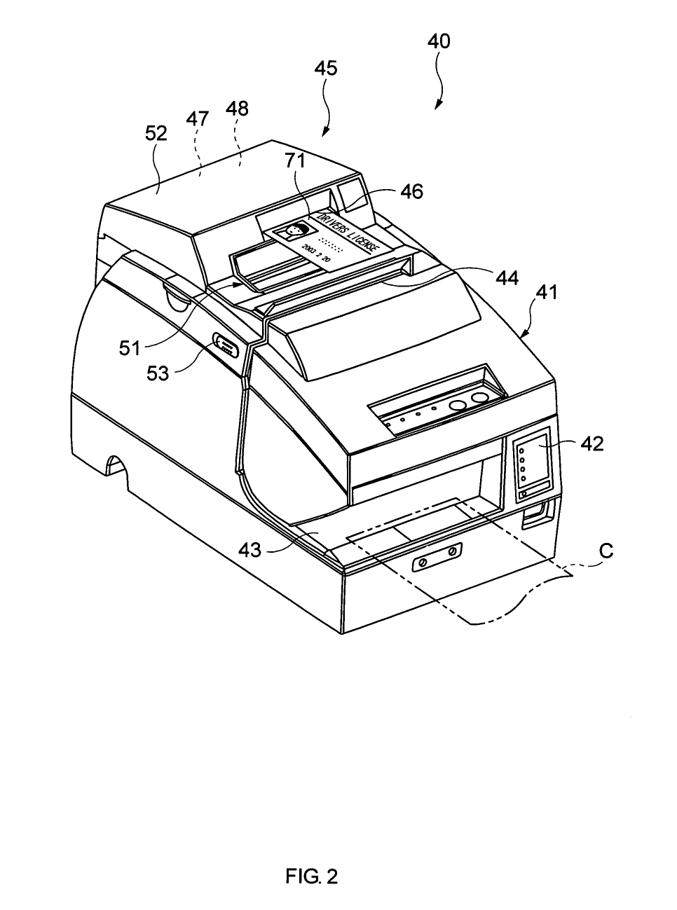

As shown in FIG. 1 and FIG. 2, a POS terminal 10 according to the present invention has a POS terminal computer 30 and a hybrid processing system 40. The POS terminal computer 30 processes transactions based on product information entered by the operator, and the hybrid processing system 40 runs various processes, including processing checks C.

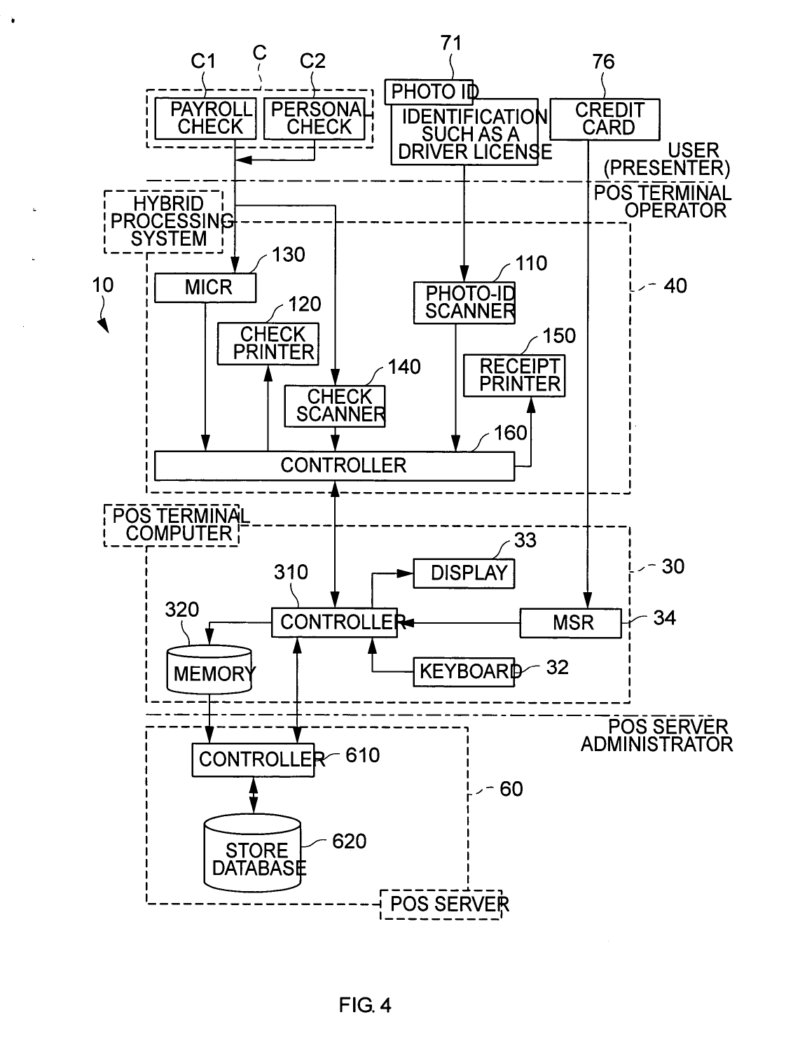

The POS terminal computer 30 has a case 31, keyboard 32 for entering product information such as product codes and prices, a display 33 for displaying the product and price information, a magnetic stripe reader (MSR) 34 for reading credit cards 76 (see FIG. 4), and a cash drawer 35 for holding cash. The POS terminal computer 30 is connected to a POS server 60 over a network 65.

The POS server 60 is connected to multiple POS terminals 10 (only three shown in the figure), and manages product information entered to the POS terminals 10. More specifically, the POS server 60 acquires product information entered to a POS terminal 10, and retrieves the previously stored product name and price information based on this product information. Based on this retrieved data, the POS server 60 then generates product data for printing to a receipt 36 or presentation on the display 33, and sends this product data to the POS terminal 10. Based on the product data sent from the POS server 60, the POS terminal 10 then generates print data for printing to a receipt 36, sends the print data to the hybrid processing system 40, and generates display data for displaying on the display 33.

The hybrid processing system 40 is connected to POS terminal computer 30 through a connector as shown in FIG. 1, and has a plastic outside cover 41. An insertion slot 43 for manually inserting check C substantially horizontally is formed at the front, and a paper exit 44 for discharging the check C is formed on top. The top back part of the outside cover 41 is a maintenance cover 52. When a sliding lock button 53 disposed at the top on one side of the outside cover 41 is operated, the maintenance cover 52 can swing up and open pivoting at the back. An indicator unit 42 is disposed at the front right side of the hybrid processing system 40. Errors and prompts, such as to scan identification 71, are displayed on the indicator unit 42. These errors and prompts could be displayed on the display 33, in which case the indicator unit 42 can be omitted.

As noted above the hybrid processing system 40 includes the function of a personal identification scanning device 110 (FIG. 4)incorporating a photo ID scanner 45 which captures an image of the presented identification 71 through the photo-ID scanner 45 provided at the back top part of the hybrid processing system 40.

The photo-ID scanner 45 has an identification scanner 47 for capturing an image of the identification 71, and an identification transportation mechanism 48 for conveying the inserted identification 71 to the identification scanner 47 and then returning the identification 71 to the insert/exit slot 46. It should be noted that this embodiment of the invention is described as capturing an image of a driver license as the identification 71, but the invention could be configured to read a variety of personal identification media, including passports, insurance cards, and student ID cards. It should also be noted that the identification 71 preferably includes a photograph of the bearer in order to improve the evidence value of the captured image.

Furthermore, the configuration of this photo-ID scanner 45 is the same as that of a common card scanner, and further description thereof is thus omitted here.

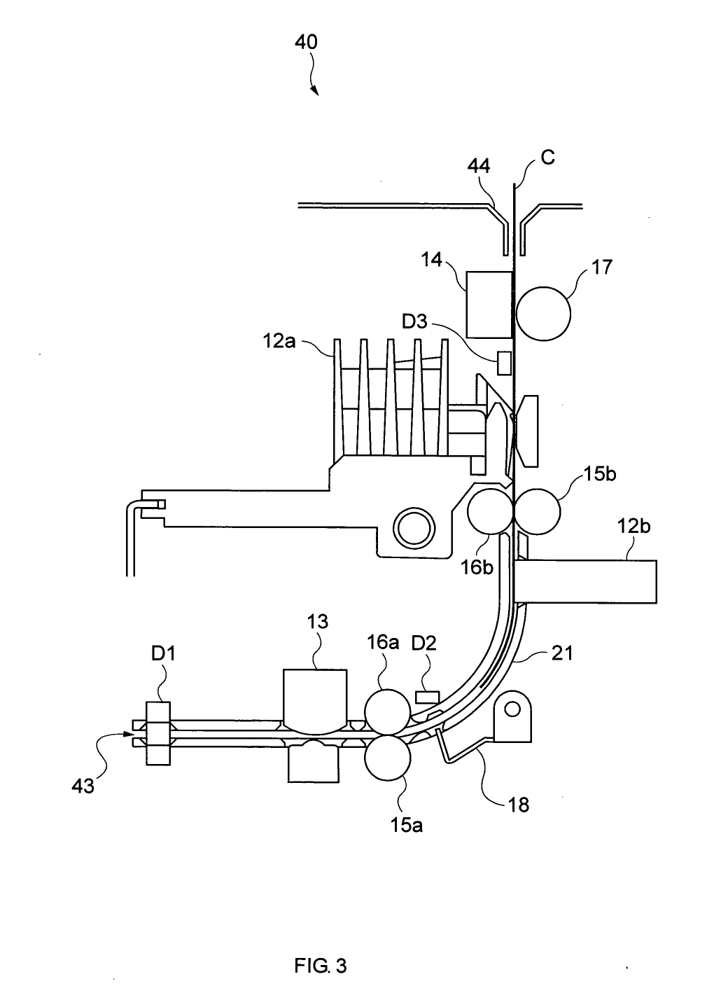

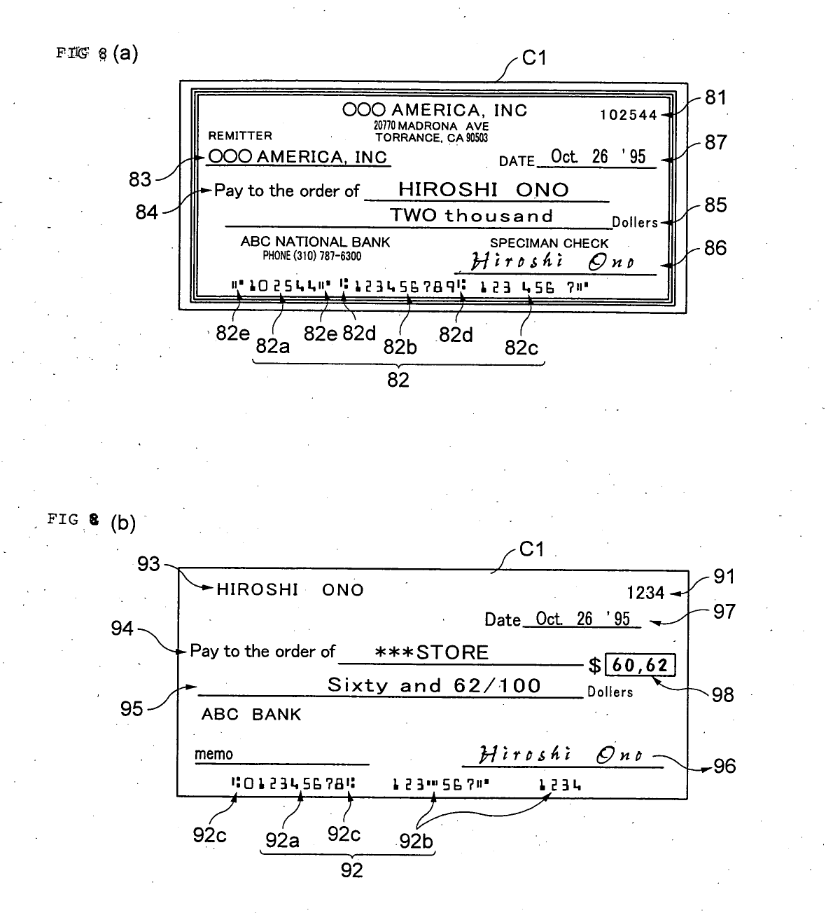

The hybrid processing system 40 also has the functions of a check reading device 140 (a “check scanner” below), a magnetic ink character reader 130 (“MICR” below), and a check printing device 120 (“check printer” below) as shown in FIG. 3. In a single device, the hybrid processing system 40 can therefore execute various check processes, including capturing check C images, reading specific check information (“MICR code” below) 251 printed in magnetic ink to the check C, and printing check amount 85, 95 and store information 84, 94 to checks C (see FIG. 8). A POS terminal 10 that can process checks C can therefore be achieved by connecting this hybrid processing system 40 to a POS terminal computer 30.

The function of a receipt printer 150 is also rendered in the middle of this hybrid processing system 40 for printing receipts 36.

At the back of the hybrid processing system 40 are disposed a receipt paper compartment (not shown) for storing receipt paper wound in a roll, a receipt printing unit 51 for printing receipt 36, and a receipt transportation mechanism (not shown) for carrying the receipt 36 paper from the roll to the receipt printing unit 51, and then discharging the printed receipt 36 from a receipt exit 54 formed in the top of the outside cover 41. The configuration of a common receipt printer can be used for this receipt printing unit 51. The receipt printing unit 51 is therefore not described in detail or specifically shown in the figures, and further description thereof is thus omitted below.

The POS terminal 10 is also connected over a network (Internet) 65 to a transaction processing server 70 for verifying check C validity. POS terminal 10 sends information relating to the MICR code 82, 92 (see FIG. 8) read by the check scanner 140 to the transaction processing server 70 to determine if the check C is valid. Based on the response from transaction processing server 215, the POS terminal 10 then determines whether the check C is valid or invalid. If the transaction processing server 70 determines that the check C is invalid, the check C becomes unusable.

The internal configuration of the hybrid processing system 40 is described next with reference to FIG. 3. FIG. 3 is a schematic side view of the inside of hybrid processing system 40. Magnetic head 13 (MICR 130), back print head 12b, front print head 12a (check printer 120), and scanner 14 (check scanner 140) are disposed from the insertion slot 43 along the transportation path 21 of the hybrid processing system 40. Checks C are conveyed along the transportation path 21 by drive rollers 15a, 15b, driven rollers 16a, 16b, and scanner 14 drive roller 17. Three sensors D1, D2, D3 for detecting paper presence are also disposed along the transportation path 21. It will be obvious that the relative positions of the print head 12, magnetic head 13, and scanner 14 can be changed and shall not be limited to the order shown here.

A form stop 18 for positioning a check C inserted from the insertion slot 43 is also rendered between the transportation path 21 drive roller 15a and the back print head 12b. The driven rollers 16a, 16b can be moved to a position contacting the drive rollers 15a, 15b, and to a position separated from the drive rollers 15a, 15b, by an actuator not shown. Linked to the opening/closing operation of these rollers, the form stop 18 is also moved to a position interceding in the transportation path 21, or a position retracted from the transportation path 21.

When rollers 15a, 16a are open, the form stop 18 is positioned interceding in the transportation path 21, and a check C can be inserted from the insertion slot 43. When sensors D1, D2 detect that a check C was inserted from the insertion slot 43, an actuator (not shown) is driven so that rollers 15a, 16a close and the form stop 18 is moved to the position retracted from the transportation path 21. The drive roller 15a is then driven to transport the check C, and magnetic ink characters on the check C surface are read by the magnetic head. Drive rollers 15b, 17 are then driven to carry the check C for processing by print heads 12a, 12b and scanner 14, and discharge the check C from paper exit 44.

Writing the front of a check C is described next with reference to FIG. 8. There are two common types of checks, payroll checks C1 such as shown in FIG. 8(a), and personal checks C2 such as shown in FIG. 8(b). Payroll checks C1 are typically two-party checks, that is, a type of check C that is written by one party to a user, who then signs the check to use it. Company checks (business checks) that are used by companies as a means to pay employee wages are payroll checks C1. Personal checks C2 are used by individuals who write the checks against their own account.

As shown in FIG. 8(a), a serial number 81, remitter name (the company issuing the check in this example) 83, check amount 85, and MICR code (check-specific information) 82 preprinted in magnetic ink for reading by the MICR 130 are printed on a payroll check (company check) C1. This invention reads the MICR code 82, and determines whether to scan and image the identification 71 based on the result of an evaluation using the read MICR code 82.

The format of the MICR code 82 used on a payroll check C1 is defined in various standard formats, such as ANSI/ABA X9.13, Specifications for Placement and Location of MICR Printing. In this example, the payroll check C1 has three fields, the Axially ON US Field 82a, Routing Field 82b, and ON US Field 82c, in order from the left side of the check C as seen in FIG. 8(a).

The Routing Field 82b contains the unique nine-digit Routing Number preassigned to each bank by the American Bank Association (ABA). The Routing Field 82b is also demarcated by a predetermined symbol (Transit Symbol) 82d specified by the ABA. Each bank can decide for itself what information to include in the ON US field 82c and Axially ON US Field 82a, but generally speaking the ON US field 82c contains the branch name and account number of the user, and the Axially ON US Field 82a contains the user's serial check number 81. The serial number 81 in the Axially ON US Field 82a is also often demarcated by a symbol 82e that is different from the Transit Symbol 82d demarcating the Routing Field 82b.

Note that while an Axially ON US Field 82a containing a printed serial number 81 is provided on the payroll check C1, this field is not used on a personal check C2 as further described below. It is therefore possible to determine the type of check C by detecting whether this Axially ON US Field 82a is present. The code printed in this field is called the leading code below.

When this payroll check C1 is then used, the check is dated 87 and signed 86 by the user (presenter), and the store information 84 is either written in by the user or the store (the POS terminal 10 operator), or is printed by the check printer 120.

In addition to the preprinted serial number 91 and user name 93, a personal check C2 also has an MICR code (check-specific information) 92 for reading by an MICR 130 preprinted in magnetic ink as shown in FIG. 8(b). The MICR code 92 is also read by an MICR 130 from a personal check C2, and based on verification of the read information, whether to scan and image the identification 71 is determined.

The format of the MICR code 92 on a personal check C2 is also defined in ANSI/ABA X9.13, and has two fields defined from the left side of the check: Routing Field 92a and ON US Field 92b. As does the Routing Field 82b on a payroll check C1, this Routing Field 92a contains the unique nine-digit routing number assigned to each bank by the ABA demarcated by a unique Transit Symbol 92c. The ON US Field 92b can be defined by the individual bank, but typically and in this example contains the user account number and serial check number. The MICR code 92 thus contains information, specifically information identifying the bank, branch, and account number, about the account of the person writing the check C.

When the personal check C2 is used, the user fills in the date 97 and signs 96 the check, and the payee (store information) 94 and check amount 95, 98 are written either manually by the user or clerk or printed by the check printer 120.

Endorsement information, including the payee name and often including the payee account number, address, and clerk that received the check if the payee is a store, is printed on the back of both payroll checks C1 and personal checks C2, but this endorsement is not shown in the figures.

The control configuration of a POS system 1 according to the present invention is described next with reference to the block diagram in FIG. 4. As described above, this POS system 1 is composed of multiple POS terminals 10 and a POS server 60 for controlling the multiple POS terminals 10. Each of the POS terminals 10 is composed of a hybrid processing system 40 for processing checks C and scanning identification 71, and a POS terminal computer 30 for transaction processing based on product information entered by the operator.

The hybrid processing system 40 has a MICR 130 for reading MICR code 82, 92 from a check C (payroll check C1 or personal check C2), a check printer 120 for printing store information 84, 94 and the check amount 85, 95 to specified locations on the check C, a check scanner 140 for imaging the check C after the check C is signed by the user, a photo-ID scanner 110 for imaging the presented identification 71 when the operator requests identification, such as a driver license, from the user, a receipt printer 150 for printing a receipt 36 based on the receipt printing data sent from the POS terminal computer 30, and a controller (CPU) 160 for controlling internal operations of the hybrid processing system 40.

The controller 160 evaluates the MICR code 82, 92 acquired by the MICR 130 and/or the transaction amount entered from a keyboard 32 described below (or the check amount information contained in the print data to be printed by the receipt printer 150), and based on the result of this evaluation determines whether to capture an image of the identification 71 by means of photo-ID scanner 110. Note that this evaluation of the MICR code 82, 92 and/or transaction amount, and determining whether to image the identification, can be done by the controller 310 of the POS terminal computer 30 described below.

The POS terminal computer 30 has a keyboard 32 for entering product information and price information, a display 33 for displaying the product information, price information, and any error messages or prompts, a MSR 34 for scanning a credit card 76 used as one means of payment, memory 320 such as ROM and RAM, and a controller (CPU) 310 for controlling internal operations of the POS terminal computer 30. Memory 320 is used to store control data (including various data tables) and a control program executed by the controller in ROM, and provides work area and registers in RAM for use as working memory for the control processes. Buffers for storing check images captured by the check scanner 140 and image data captured by the photo-ID scanner 110 are also provided in RAM, which is used to temporarily store such data sent from the hybrid processing system 40.

The POS server 60 has a store database 620 for storing product codes and related price information, and acquiring and storing check data and identification data temporarily stored in memory 320 in the POS terminal computer 30, and a controller (CPU) 610 for managing data stored in store database 620 and controlling the POS server 60 and the multiple POS terminals 10 connected thereto. There is usually one POS server 60 per store, and a POS server administrator maintains, tests, and manages the POS server 60.

Check data acquired by the POS server 60 (or credit card 76 data captured by the MSR 34) and identification data are managed linked to a previously stored customer database (not shown), and is used for customer management and as a record of proof of illegal use.

Check C processing is described next.

When the operator receives a check C from a customer (user), the operator has the customer sign the check on the signature line 86, 96 (see FIG. 8), and then inserts the check C to the insertion slot 43 (see FIG. 2) for check C verification. When a check C is inserted, the MICR code (check-specific information) 82, 92 printed in magnetic ink is read and recognized by the magnetic head 13 (MICR 130). Note that this character recognition process could be done by OCR using the scanner 14 (check scanner 140).

When the MICR code 82, 92 is read, the information is sent to POS terminal computer 30, which then transfers the data over network 65 to transaction processing server 70. Whether the check C is valid or not is then determined based on the response from the transaction processing server 70. If the check C is determined invalid, drive roller 15 is driven in reverse to discharge the check C from the insertion slot 43. An error is also displayed on the indicator unit 42 (see FIG. 2), and an error telling the operator that the check C is invalid is displayed on the display 33 of the POS terminal computer 30.

If the check C is determined valid, the system waits for the operator to enter the check amount (transaction amount) 95 and the store information 84, 94. When the check amount (transaction amount) 95 and the store information 84, 94 are entered, the check printer 120 prints the information to specified places on the check C. More specifically, the front print head 12a prints the check amount 95 to a specified position on the check C face, and the back print head 12b prints the endorsement information to a specified position on the back of the check C.

Based on the information (character recognition results) read from the MICR code 82, 92 and/or the transaction amount, the POS terminal 10 then determines whether to scan the identification 71. The conditions used to evaluate the MICR code 82, 92 are predefined by an operator or administrator, and the evaluation is controlled by these conditions. If the result is to capture an image of the identification, the operator is prompted by the indicator unit 42 and display 33 to insert the identification 71 for scanning, and the identification 71 is then imaged by the photo-ID scanner 110. If scanning the identification 71 is determined unnecessary, the next step (such as scanning the check C with check scanner 140) in processing the check C is executed.

Conditions for evaluating the MICR code 82, 92 are further described below.

When printing the check amount 95 and store information 84, 94 is finished, drive roller 17 is driven to scan and image the front of the check C by means of scanner 14 (check scanner 140). When scanning the check C front is completed, the check C is ejected from the paper exit 44. If the back side of the check C is also to be scanned, the check C is inserted from the insertion slot 43 again with the back side facing up so that an image of the check back can be captured by the scanner 14 (check scanner 140).

If the identification is also to be scanned and an image captured, the identification is scanned by the photo-ID scanner 110 after scanning the check C is completed. If the check C is a payroll check C1, the transaction amount (transfer amount) is entered as the check amount, but the amount of cash (change) returned to the customer (user) is the transaction amount minus the total of product purchases.

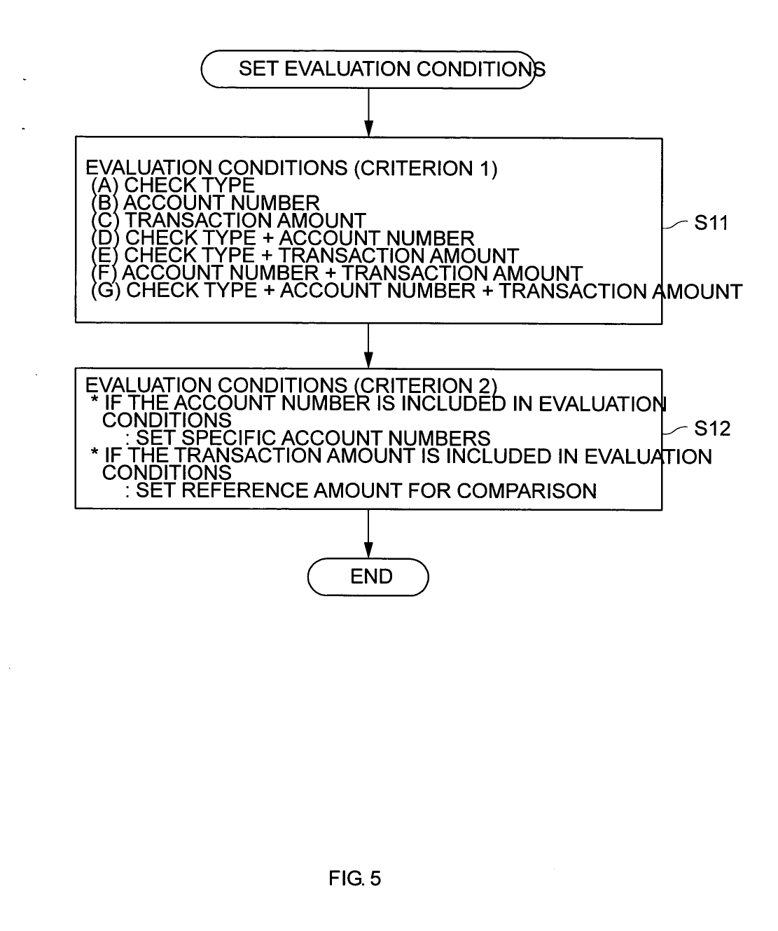

A method for setting the conditions (criteria) for evaluating the MICR code 82, 92 (check-specific information) is described next with reference to the flow chart in FIG. 5.

As shown in FIG. 5, seven conditions (A) to (G) are defined in this embodiment of the invention (S11). These conditions are: (A) check type, (B) account number, (C) transaction amount, (D) check type+account number, (E) check type+transaction amount, (F) account number+transaction amount, and (G) check type+account number+transaction amount. Note that “+” here denotes a logical AND, that is, when two or more conditions are combined (as in conditions (D) to (G)), all of the two or more conditions must be satisfied.

The check type is identified from the read MICR code 82, 92 (more precisely, whether the leading code (Axially ON US Field) 82a is present). This condition is used to detect if the scanned check C is a payroll check C1 (see FIG. 8(a)).

The account number is the account number read from the MICR code 82, 92. This condition is used to look for a match with predefined specific account numbers that are flagged as high risk accounts.

The transaction amount is the transaction amount acquired from the amount value sent from the POS terminal computer 30 (the check amount entered from the keyboard 32 or the print data printed by the receipt printer 150). This condition determines if the transaction amount is greater than or equal to a predetermined threshold amount.

Therefore, if condition (G), that is, check type+account number+transaction amount, is applied, whether the check C is a payroll check C1, whether the account number matches an account number flagged as a high risk account, and whether the transaction amount exceeds a predetermined amount are determined, and identification 71 is scanned only if all three of these conditions are true.

Note that these specific conditions can be set using the keyboard 32 of the POS terminal computer 30.

After the evaluation criteria are selected in S11, the specific conditions are set in step S12.

In this example specific account numbers must be flagged if the account number is included in the evaluation criteria. Likewise, if the transaction amount is included, the reference amount must be set. These specific conditions can also be set using the keyboard 32 of the POS terminal computer 30.

The conditions can also be defined using, for example, buttons (A) to (G) on the hybrid processing system 40 corresponding to the conditions (A) to (G) instead of using the keyboard 32 of the POS terminal computer 30. This assumes that the flagged account numbers and reference amount set in S12 have already been set using the keyboard 32 of the POS terminal computer 30.

Furthermore, rather than the operator of the POS terminal computer 30 setting these conditions using the keyboard 32, the conditions could be acquired over the network 65 from the POS server 60 or transaction processing server 70. This enables the same criteria and information to be quickly applied to all POS terminals 10 in a store having multiple POS terminals 10 connected to a POS server 60, thereby assuring that the same criteria are used by all POS terminals 10 when evaluating the MICR code 82, 92.

It will also be obvious that while the account number condition described above looks for a match between the account number captured from the check C and the preset account numbers flagged as high risk, the condition could be defined to look for account numbers that do not match the specified account numbers. In this case, only account numbers believed to be low risk accounts are set as the specified account numbers.

If no evaluation conditions are set, identification 71 is scanned and captured for all checks C. The evaluation conditions could, of course, also be set to not scan identification 71 for users of any check C.

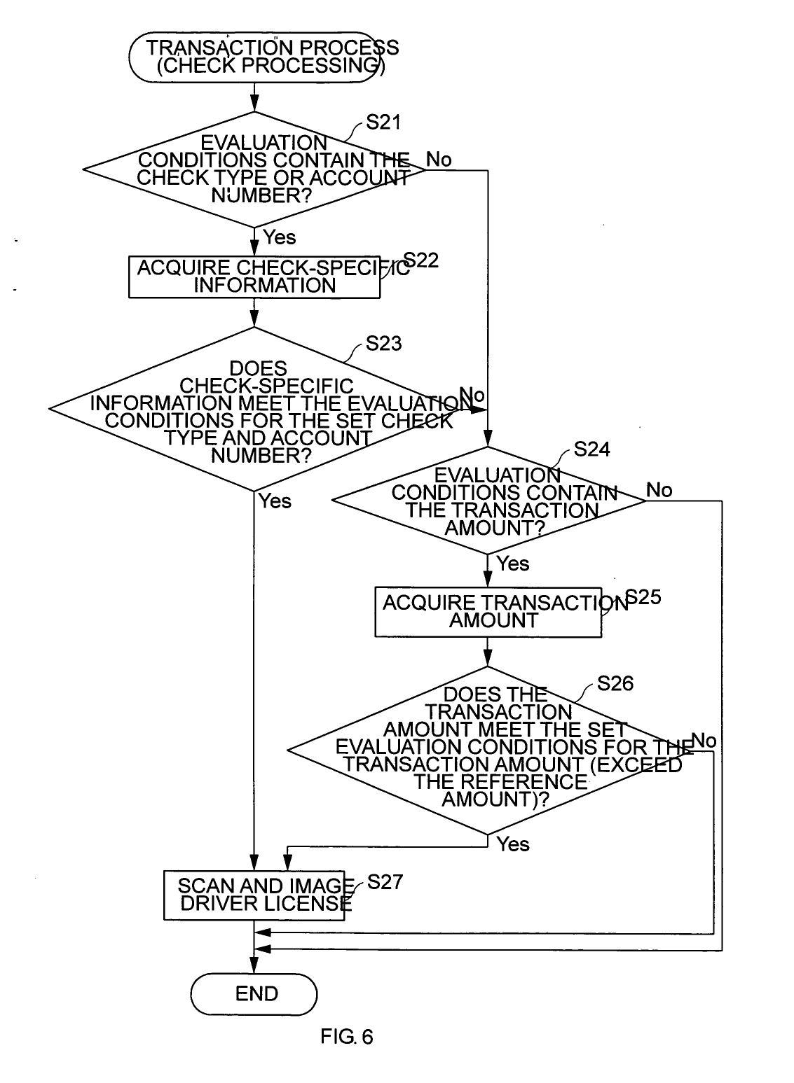

Transaction processing (check processing) based on the above evaluation conditions is described next with reference to the flow chart in FIG. 6.

If the check type or account number is included in the preset evaluation conditions (see S11, FIG. 5) (S21 returns yes, that is, any condition other than (C) is set), the check-specific information (MICR code) 82, 92 read by the MICR 130 is acquired (S22). If the check type and account number are not included in the evaluation conditions (S21 returns no, that is, condition C is used), the check-specific information 82, 92 is not acquired.

The check-specific information 82, 92 could be acquired regardless of what evaluation conditions are used, but in this case processing continues without considering the check-specific information 82, 92.

After the check-specific information (MICR code) 82, 92 is acquired (S22), whether the check-specific information satisfies the conditions defined for the check type and account number is determined (S23). In this example, if a condition containing either the check type or account number is set (conditions (A), (B), (E), and (F)), whether the check type or account number meets the defined conditions is determined; if condition (D) or (G) is set, whether both conditions are met is determined. If the evaluation condition is met (S23 returns yes), the user is prompted to scan the driver license (identification) 71 by the indicator unit 42 and display 33, and the identification is scanned and imaged after the operator inserts the driver license.

If the check type or account number is not included in the evaluation condition (S21 returns no, that is, condition (C) is used), or the check-specific information 82, 92 does not meet the set conditions (S23 returns no), whether the transaction amount is included in the evaluation condition is determined (S24). If the transaction amount is included (conditions (C) and (E) to (G)), the transaction amount is acquired from the check amount entered from the keyboard 32 or the print data for printing to the receipt 36 (S25). Whether the transaction amount meets the evaluation criteria relating to the set transaction amount is then determined (that is, whether the transaction amount exceeds the specified reference amount (see S12 in FIG. 5)) (S26). If the transaction amount exceeds the specified reference amount (S26 returns yes), the identification 71 is scanned and imaged.

If step S24 determines that the transaction amount is not included in the evaluation condition (conditions (A), (B), (D)), or the transaction amount does not meet the evaluation criteria relating to the transaction amount (S26 returns no), scanning the identification 71 is determined unnecessary and the process ends without imaging the identification 71.

Because the scanning mode is automatically entered if the check-specific information 82, 92 or transaction amount are determined to meet the specified evaluation conditions (S23 or S26 return yes), processing will not proceed unless a reset process is executed if the identification is not scanned. In other words, the operator is essentially forced to scan the identification 71.

The check processing method of the present invention thus scans and images identification 71 only when determined necessary based on check-specific information printed in magnetic ink on the check C or the transaction amount (that is, only when a check C considered to be of potential high risk or loss is used), rather than for all users. Evidence of high risk checks C (i.e., a record of a crime) can therefore be captured and stored without lowering overall productivity.

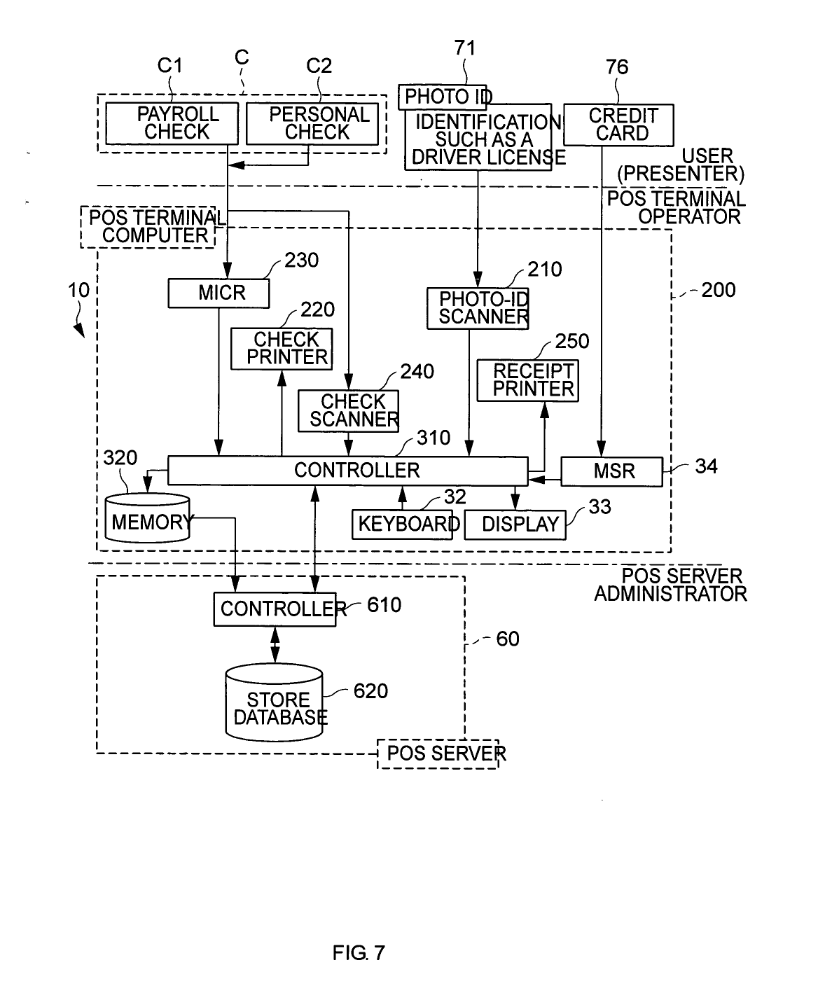

A second embodiment of the present invention is described next with reference to FIG. 7. The POS terminal computer 30 and hybrid processing system 40 are used connected to each other in the first embodiment described above. This embodiment of the invention differs from the first embodiment in that it assembles the functions of the above hybrid processing system 40 into a single case (that is, inside POS terminal computer 200). This second embodiment is therefore described briefly below focusing on these differences.

As shown in the block diagram in FIG. 7, a POS terminal computer (POS terminal) 200 according to this embodiment of the invention has an MICR 230 for reading MICR code 82, 92 from a check C (payroll check C1 or personal check C2); a check printer 220 for printing store information 84, 94 and check amount 95 to specific places on the check C; a check scanner 240 for capturing an image of the check C after it is signed by the user; a photo-ID scanner 210 for imaging the identification 71 when the user requires a driver license or other identification 71; a receipt printer 250 for printing receipt 36 based on print data generated for printing a receipt; MSR 34 for reading a credit card 76, which is one method of payment; a keyboard 32 for entering product information and price information; a display 33 for displaying product information, prices, errors and prompts; memory 320 including ROM and RAM; and a controller (CPU) 310 for controlling internal operations of the POS terminal computer 200.

The POS server 60 is configured as in the first embodiment, and further description thereof is thus omitted.

It will thus be apparent that a POS terminal computer 200 according to this embodiment of the invention can run the full sequence of operations from entering product information to processing checks C, printing receipts 36, and scanning identification 71 in a single unit. Unlike with the first embodiment, it is therefore not necessary to connect a hybrid processing system 40 to POS terminal computer 30, or install drivers for connecting the hybrid processing system 40. Furthermore, because the POS terminal is contained in a single unit, it requires less installation space and is easier to deliver and install.

The functions (means) of the hybrid processing system 40 and POS terminal computer 30, 200 shown in the first and second embodiments can also be provided as a computer-executable program. Furthermore, by storing this program on a recording medium (not shown) and installing the program to a personal computer, for example, the check processing method of the present invention is not limited to execution by a POS system 1 as shown in the above embodiment and can be achieved by other means.

The recording medium for this program could be CD-ROM, flash ROM, memory card (Compact Flash (R), Smart media, memory discs), Compact Disc, magneto-optical disc, DVD, floppy disk, or other medium.

By having a photo ID scanner for capturing an image of identification 71 presented by the person using a check C, the check processing apparatus (hybrid processing system 40), program, recording medium, POS terminal, and POS system of the present invention can quickly scan the identification 71 and create a transaction record that can be used as evidence of a crime in the event a check C is used illegally (including check forgery).

Furthermore, identification 71 is not scanned for all users. Instead, the MICR code 82, 92 printed in magnetic ink to the check C is read, and specific information contained in the MICR code is evaluated to determine whether to scan identification 71. Therefore, if identification is scanned only when a check C for an amount that could result in large financial loss is used (such as when the check C is a payroll check C1 used to pay wages), proof of high risk checks C can be efficiently created without lowering overall productivity.

Furthermore, the operator of the hybrid processing system 40 can know whether to scan the identification 71 because a prompt indicating the result of the decision concerning whether to scan the identification 71 is presented on indicator unit 42 and display 33.

Furthermore, by determining to scan identification 71 if the check type is one of the evaluation conditions and the check C is recognized as a payroll check C1 used for paying wages, for example, the loss can be minimized in the event the check C is used illegally. That is, a personal check C2 is written for the amount of products purchased and any loss is therefore relatively small if the check C is bad, but payroll checks C1 are used to pay wages, are therefore usually written for relatively large amounts, and can thus result in greater financial loss.

Furthermore, when the account number is one of the evaluation conditions, determining whether to scan identification 71 is based on the account information contained in the MICR code 82, 92. If account information for an account of a company considered high risk is acquired, this information can then be used to determine whether to scan identification 71, for example. If the transaction amount is then also included in the evaluation conditions, and the transaction amount exceeds a predefined reference amount, the identification 71 is also scanned. Evidence of a crime can therefore be generated if the check is used illegally and the loss is great. Losses can therefore be minimized.

Furthermore, because the POS terminal 10 operator can change and set the specific account numbers considered risky and the reference amount, the evaluation criteria can be set according to the specific needs of the business (the location of the store or current conditions, or conditions determined by the business).

The operator is notified when scanning the identification 71 is necessary in these embodiments, but the result of this determination could be displayed on the indicator unit 42 or display 33. More specifically, messages such as “This check is a payroll check,” “This check is drawn on a flagged account,” or “The transaction amount exceeds the reference amount” could be displayed. In this case the identification scanning mode is not entered automatically according to this result, but instead is entered when the operator actually inserts the identification 71 to the scanner. In this case the operator can determine whether to scan the identification 71 with consideration for the displayed results.

Furthermore, the evaluation conditions are predefined in the above example, but any one or more of the check type, account numbers, and transaction amount could be stored as the evaluation conditions in the hybrid processing system 40 or POS terminal computer 30, 200. This eliminates the need for the operator to set the evaluation conditions.

Furthermore, the identification 71 is scanned and imaged based on defined evaluation conditions, the acquired check-specific information 82, 92, or the transaction amount in the embodiments described above, but the invention shall not be so limited. More specifically, whether to scan identification 71 could be determined and controlled completely by the operator without reference to these conditions or information.

More specifically, if the operator determines that it would be better to scan the user's identification 71, the operator could simply insert the identification 71 to the scanner after entering product information from the keyboard 32 or scanning the check C with check scanner 140, 240, and before the receipt is output.

This configuration enables eliminating the evaluation process and simplifies the control process, and can therefore lower the cost of the hybrid processing system 40 and POS terminal computer 30, 200.

Furthermore, the check type, account number, and transaction amount are used by way of examples as the evaluation conditions above, but the invention shall not be so limited and other conditions can be defined according to the specific needs of the business.

The invention shall also not be limited to the system or component configurations described above and can be varied in many ways without departing from the scope of the accompanying claims.

As will be known from the preceding description, a check processing apparatus, program, recording medium, POS terminal, and POS system according to the present invention acquire check-specific information printed in magnetic ink on a check, and based on an evaluation of the acquired information captures an image of personal identification provided by the check user as a record of the transaction and potential crime. Illegal check use can therefore be prevented effectively without reducing POS terminal productivity.

1. A check processing apparatus comprising:
a scanning device for imaging personal identification information of a person presenting a check;
a magnetic reader for reading check-specific information preprinted in magnetic ink to the check and identifying the check;
evaluation means for evaluating check-specific information on said check in accordance with predefined evaluation standards; and
a scanning determination means for determining whether to activate said scanning device to capture an image of said personal identification based on the evaluation result of said evaluation means.

2. A check processing apparatus as described in claim 1, further comprising a reporting means for reporting the evaluation result from the evaluation means and/or the decision of the scanning determination means.

3. A check processing apparatus as described in claim 1 wherein the predefined evaluation standards include a determination of the check type as a two party payroll check or other two-party check issued by someone other than the presenter and payable to the presenter upon signing by the presenter.

4. A check processing apparatus as described in claim 3 further comprising means for setting or resetting the evaluation standards.

5. A check processing apparatus as described in claim 1, wherein said POS terminal computer is in communication with a POS server adapted to communicate evaluation standards with said check processing apparatus further comprising means for acquiring evaluation standards from said POS server to be used as a basis for the evaluation by the evaluation means.

6. A check processing apparatus as described in claim 2, wherein said POS terminal computer is in communication with a POS server adapted to communicate evaluation standards with said check processing apparatus further comprising means for acquiring evaluation standards from said POS server to be used as a basis for evaluation by the evaluation means

7. A check processing apparatus as described in claim 5, wherein the evaluation standard is supplied over a network.

8. A check processing apparatus as described in claim 6, wherein the evaluation standard is supplied over a network.

9. A check processing apparatus as described in claim 3 wherein the check-specific information includes account information denoting a checking account on which the check is drawn, and
wherein said evaluation standards comprise said account information.

10. A check processing apparatus as described in claim 5 wherein the check-specific information includes account information denoting a checking account on which the check is drawn, and
wherein said evaluation standards comprise said account information.

11. A check processing apparatus as described in claim 1 further comprising:
a transaction information acquisition means for acquiring transaction amount information from the POS terminal computer;
a reference amount setting means for setting a reference amount for evaluating the transaction amount; and
a transaction amount evaluation means for determining if the transaction amount exceeds the set reference amount;
wherein the scanning determination means decides to activate said scanning device to scan and image the personal identification of the presenter of the check when the transaction amount evaluation means determines the transaction amount exceeds the reference amount.

12. A check processing apparatus as described in claim 5 further comprising:
a transaction information acquisition means for acquiring transaction amount information from the POS terminal computer;
a reference amount setting means for setting a reference amount for evaluating the transaction amount; and
a transaction amount evaluation means for determining if the transaction amount exceeds the set reference amount;
wherein the scanning determination means decides to activate said scanning device to scan and image personal identification of the presenter of the check when the transaction amount evaluation means determines the transaction amount exceeds the reference amount.

13. A check processing apparatus comprising:
a scanning device for imaging personal identification presented by a person using a check;
a transaction information acquisition means for acquiring transaction amount information;
a reference amount setting means for setting a reference amount for evaluating the transaction amount;
a transaction amount evaluation means for determining if the transaction amount exceeds the set reference amount; and
scanning means for activating said scanning device to capture an image of the personal identification when the transaction amount evaluation means determines that the transaction amount exceeds the set reference amount.

14. A POS system including a check processing apparatus for processing checks when presented for purchase of product relating to product transactions based on product information entered by an operator into a POS terminal computer connected to the check processing apparatus comprising:
a check reading means for reading check-specific information preprinted in magnetic ink to the check and identifying the check;
an evaluation condition setting means for setting evaluation conditions for evaluating the check-specific information;
evaluation means for evaluating whether the check-specific information satisfies the evaluation conditions; and
a scanning means for capturing an image of personal identification information of the person presenting the check when the specific information evaluation means determines that the evaluation conditions are satisfied.

15. A POS system as described in claim 14, wherein the evaluation conditions are selected from the group consisting of:
(a) the type of check presented and if a payroll check or other two-party check has been issued by someone other than the presenter;
(b) the preset evaluation criteria contained in the check-specific information, and
(c) whether the transaction amount exceeds a preset reference amount.

16. A POS system as described in claim 15 further comprising a POS server connected to and centrally controlling the POS terminal via a network.

17. A POS system as described in claim 14 wherein the check processing apparatus and POS terminal computer are integrally housed in a single case.

18. A POS system as described in claim 16 wherein the check processing apparatus and POS terminal computer are integrally housed in a single case.

19. A method for processing checks when processing transactions relative to product information using a POS terminal computer and a check processing apparatus including a scanning device for scanning an image of the presenter of each check comprising the steps of:
(a) establishing a set of evaluation conditions for evaluating each check presented in payment of product processed by the POS terminal computer
(b) capturing an image of personal identification of the person presenting the check when the set of evaluation conditions are satisfied

20. A method as defined in claim 19 wherein the evaluation conditions are selected from the group consisting of:
(a) the type of check presented and if a payroll check or other two-party check has been issued by someone other than the presenter;
(b) the preset evaluation criteria preprinted in magnetic ink to the check and identifying the check and
(c) whether the transaction amount exceeds a preset reference amount.
